(19) United States
(12) Patent Application Publication
(10) Pub. No.: US 2010/0330903 A1
(43) Pub. Date: Dec. 30, 2010

(54) METHOD AND DEVICE FOR THE TRANSMISSION OF DATA BETWEEN COMMUNICATING MOBILE TERMINALS

(76) Inventor: Christian Chabrerie, Paris (FR)

Correspondence Address: YOUNG & THOMPSON, 209 Madison Street, Suite 500, Alexandria, VA, 22314, US

(21) Appl. No.: 12/095,571

(22) PCT Filed: Nov. 30, 2006
(86) PCT No.: PCT/FR06/02620

§ 371 Date: Sep. 3, 2010

(30) Foreign Application Priority Data
Nov. 30, 2005 (FR) 0512123

(51) Int. Cl. H04B 7/24

(52) U.S. Cl. 455/39

(57) ABSTRACT

The method includes the following steps:
an identification step of a first communicating mobile terminal in a distant memory, the identification depending on the localization of the first communicating mobile terminal,
a correspondence search step of the first communicating mobile terminal identification with an identification list of terminals associated with a second communicating mobile terminal, the step of correspondence search depending on the proximity of the first and second communicating mobile terminals, and
in case of correspondence, a supply step to the second terminal user of information representative of the first terminal identification. Preferably, the identification step of the first communicating mobile terminal in a distant memory is carried out by a direct point-to-point radio link between the first communicating mobile terminal and a third-party communicating terminal and the correspondence search step is carried out by the second communicating mobile terminal at reception, coming from a third-party communicating terminal.

The invention relates to a method and a device for the transmission of data between communicating mobile terminals.

The scope of this industrial application is the one of communicating mobile terminals for example mobile phones and/or communicating portable computers, for example laptops, PDA (acronym for Personal Digital Assistant) or games consoles.

We know many means to communicate wireless between mobile phones and/or portable computers, like, for example, the infra-red communications like IrDA (registered trademark, acronym for Infrared Data Association), the radio links like Bluetooth (registered trademark), WiFi (registered trademark, acronym for Wireless Fidelity). Some PDAs or high-end mobile phones have almost all these communication means.

However, in order to be able to establish a presence detection between two terminals, a problem consists in detecting from a communicating mobile terminal, and in a configurable space-time proximity, the presence of predetermined communicating terminals and transmitting them the information that the two communicating mobile terminals are in the same place, at the same time and an identification information of the other terminal.

The prior art, in its standard embodiment, for example the Mobiluck (registered trademark) software detects, via a short range radio link, for example Bluetooth, the presence of close terminals by using a direct connection, i.e., in point-to-point mode.

So, prior art does not enable to detect nor to further dialog further down than the direct local radio range. The present invention aims at solving these disadvantages.

To that aim, according to a first aspect, the present invention relates to a method for the transmission of data between communicating mobile terminals, characterized in that it comprises:
an identification step of a first communicating mobile terminal in a distant memory, said identification of the first communicating mobile terminal in the distant memory depending on the localization of the said first communicating mobile terminal,
a correspondence search step of the identification of the first communicating mobile terminal with an identification list of terminals associated with a second communicating mobile terminal, said correspondence search step depending on the proximity of the said first and second communicating mobile terminals and
in case of matching, a supply step to the second terminal user of information representative of the first terminal identification.

Thanks to these features, the user of a terminal out of range of a direct local radio communication of another terminal can nevertheless be informed of the proximity of another user of which he referenced the terminal identification.

According to particular features, the identification step of the first communicating mobile terminal in a distant memory is carried out by a direct radio link between said first communicating mobile terminal and a third-party communicating mobile terminal different from said first and second communicating mobile terminals.

Thanks to these features, third-party terminals can transport the information of the presence of the first communicating mobile terminal to the second communicating mobile terminal. This way, we avoid using communications with the telecommunication network infrastructure.

According to particular features, the correspondence search step is carried out by said second communicating mobile terminal at reception, coming from another communicating terminal different from the first communicating mobile terminal, of identifications of communicating mobile terminals.

Thanks to these features, each terminal receives the identification of the communicating mobile terminals which are in the proximity but out of their direct range and determine those of them which are referenced by the second communicating mobile terminal. This way, we avoid using third-party calculation resources or the telecommunication network.

According to particular features, the identification step of the first communicating mobile terminal in a distant memory is carried out by the first communicating mobile terminal which jointly transmits said identification and information representative of its localization.

Thanks to these features, a central server can manage the localizations, identifications and identifications lists and inform the users which are near each other.

According to particular features, during the identification step of the first communicating mobile terminal in a distant memory, the first communicating mobile terminal determines its localization according to hertzian positioning radio signals.

Thanks to these features, the localization of each terminal can be very precise, for example by implementing satellite radio signals.

According to particular features, during the identification step of the first communicating mobile terminal in a distant memory, the first communicating mobile terminal determines its localization by the identification of at least one hertzian emitter-receiver radio signal in direct range.

Thanks to these features, the localization of each terminal is easy since it uses a cell or access-point information to which a terminal is connected. The terminal or the communication infrastructure associated with the emitter-receiver can thus determine the localization of each terminal.

According to particular features, the identification step of the first communicating mobile terminal in a distant memory is carried out by a transmission by a communication network, of the identification of an emitter-receiver to which the first communicating mobile terminal has connected.

Thanks to these features, a central server can manage the localizations, identifications and identifications lists and inform the users who are near each other.

According to particular features, the search step is carried out by a server distant from the first communicating mobile terminal, this server having access to said list.

Thanks to these features, a central server can manage the localizations, identifications and identifications lists and inform the users who are near each other.

According to particular features, the method of the present invention as briefly exposed above includes, in case of correspondence, a supply step to the first terminal user of information representative of the second terminal identification.

Thanks to these features, each user being near from each other is informed of this proximity and can, consequently, take the initiative to communicate with him.

According to a second aspect, the present invention aims, a device for the transmission of data between communicating mobile terminals, characterized in that it comprises:
an identification means of a first communicating mobile terminal in a distant memory, said identification of the first communicating mobile terminal in the distant memory depending on the localization of the said first communicating mobile terminal,
a correspondence search means of the first communicating mobile terminal identification with an identifications list of terminals associated with a second communicating mobile terminal, adapted to that said correspondence search depends on the proximity of the said first and second communicating mobile terminals and
a supply means adapted, in case of correspondence, to provide to the user of the second terminal, information representative of the first terminal identification.

The advantages, goals and particular features of this device being similar to those of the method such as briefly exposed above, they are not again pointed out here.

Other advantages, goals and features of the present invention will arise from the description which follows, made, with an explanatory aim and by no means restrictive compared to the annexed drawings in which:

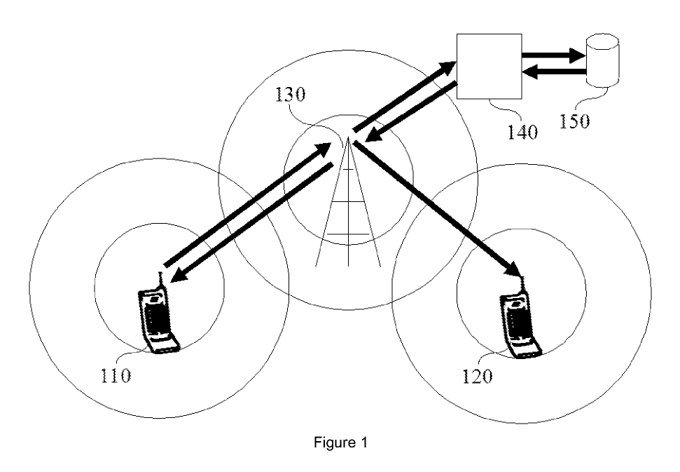

FIG. 1 represents, schematically, a first particular embodiment of the device of the present invention;

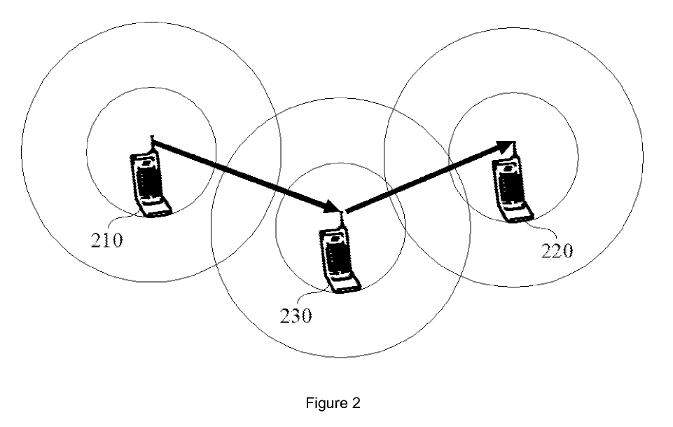

FIG. 2 represents, schematically, a second particular embodiment of the device of the present invention;

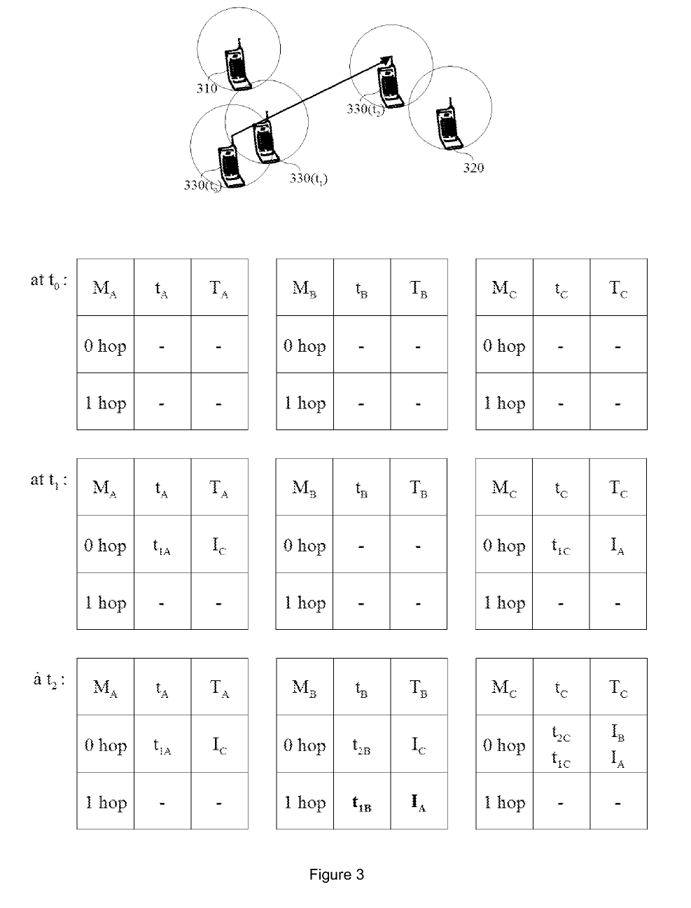

FIG. 3 represents, schematically, a third particular embodiment of the device of the present invention;

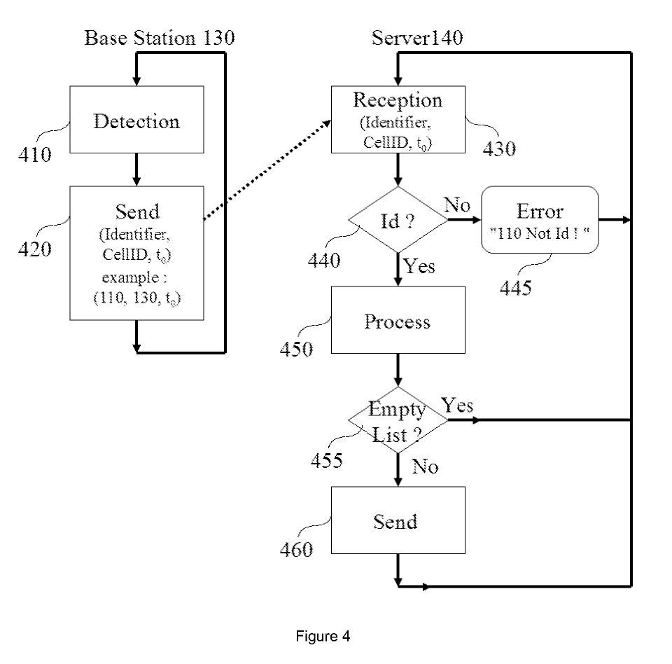

FIG. 4 represents, in a state-diagram form, steps implemented in a first alternative of the first embodiment of the method of the present invention;

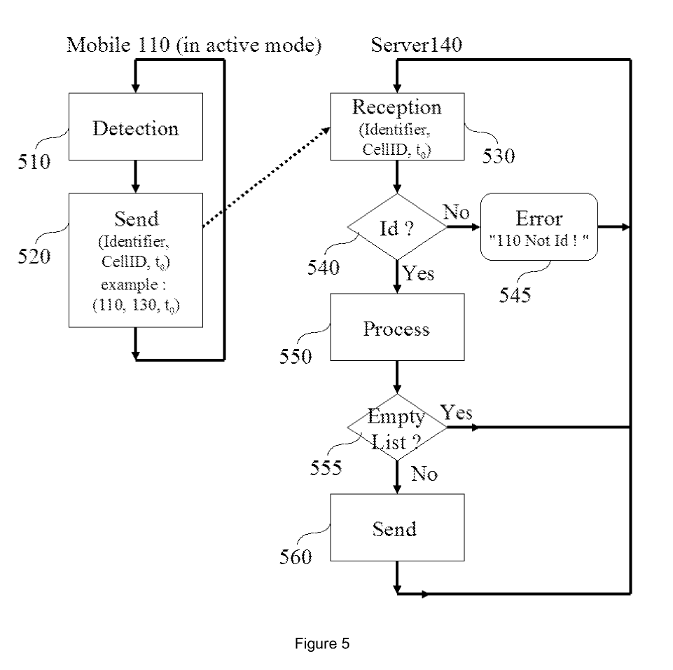

FIG. 5 represents, in a state-diagram form, steps implemented in a second alternative of the first embodiment of the method of the present invention and

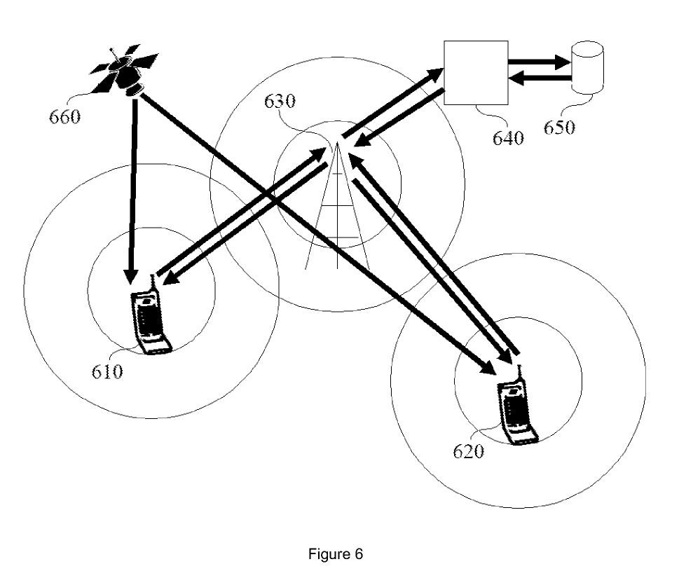

FIG. 6 represents, schematically, a fourth particular embodiment of the device related to the present invention.

A user is characterized by his identifier. This identifier is for example its mobile phone number, preferentially in encrypted form. While subscribing to a proximity detection service, the user defines an identification list of “targets” communicating mobile terminals, for example its favorite mobile phone numbers or its Skype (registered trademark) correspondents. According to the embodiment of the method of the present invention, this list is stored in its communicating mobile terminal, and then can be the same as the contact list stored in this terminal, or in a database of a distant server of this communicating mobile terminal. In this last case, the entry of the list in database is carried out by the communicating mobile terminal, starting from the phone numbers stored in the telephone or preferentially in SIM card (acronym for Subscriber Identity Module) and for the server via a GSM network (acronym for Global System for Mobile Communications).

It is noted that, with the present invention, the data transmission between communicating mobile terminals can be limited to the communication of the identifier from one terminal to another. The data can also contain other information items like the name, first name, pseudonym, physical leisure, tastes, age, sex, physical characteristics, list of what we like, list of what we do not like, photo, curriculum vitae, business card of the user, etc.

The user of the communicating mobile terminal can, at any time, choose to be not localized anymore. The user chooses the emission mode of his data: to detect and be detected, detect without being detected, being in emission mode of a particular state (accessible, absent, not available, not to disturb, for example) or completely inactive, i.e. not to transmit data. As in the current mobile phones for the ringing operating processes, he can define several emission modes of his data and associate specific alert modes to each group of target identifiers (for example professional or personal contacts). A programmable function can change these operating modes according to the hour and the day for example. Another possible function for the user is to display, for a given group of identifiers their respective estimated distances.

In the first embodiment of the method of the present invention, illustrated in FIG. 1, we use a server connected to an infrastructure of at least one cellular communication network. This first embodiment consists in transmitting to a server 140, localization information and identification information of the terminal to indicate him where the users of this service are. For example, this step is carried out during the connection phase of the terminal to a base station of this network.

In a first alternative, illustrated by the state-diagram FIG. 4, during the connection of the communicating mobile terminal 110 to the base station 130, a detection step 410 is activated during acceptance, at t0, of this new connection. The base station 130 sends, step 420, via the cellular network infrastructure, to a server 140, information indicating that the communicating mobile terminal 110 has just connected to the base station 130. After reception by server 140, step 430, server 140 checks that the terminal 110 identification is contained in the list of the subscribers to the service, step 440. If the identification is not in this list, during a step 445, an error message is generated and, eventually, transmitted to terminal 110 and the server returns to step 430.

If the identification of terminal 110 is contained in the list of subscribers, server 140 carries out a processing step 450 which, in the example of FIG. 4 comprises: the writing in database 150 of the identifier of 110 in identifiers list connected to the base station 130, the reading of database 150 of the L110 list of the target identifiers of terminal 110, the reading of database 150 of the L130 list of the identifiers connected to the base station 130 and the determination of the identifiers list common to L110 and L130. In the example, the result contains identifier 120.

Reciprocally, the server checks if the identification of the communicating mobile terminal 110 is in the identifiers target list of the communicating mobile terminals connected to the base station 130 during the processing step 450 and inserts it in the list of the common identifiers.

During a step 455, server 140 determines if this last list of the common identifiers is not empty. If it is empty, the server returns to step 430.

If, in the identifiers list of the communicating mobile terminals connected to the base station 130, there is at least one identifier which is also in the list of the target identifiers of the communicating mobile terminal 110, server 140 sends, step 460, a message of proximity indication to the two communicating mobile terminals and provides them the identification of the other communicating mobile terminal.

The advantage of this first embodiment is that the necessary traffic is very low and remains local to the base station 130. It is noticed that, in practice, if we want that the Database is preferentially accessible from Internet, we will move it up from the BTS (acronym for Base Transceiver Station) to the BSC (acronym for Base Station Controller) or to the HLR (acronym for Home Location Register).

To implement this first embodiment, the server carries out a centralized update of the <<target>> identifiers list of each user subscribed to the service. For example, a Java application (registered trademark), in the SIM card regularly sends from the communicating mobile terminal 110 to server 140 the <<target>> identifiers list of the communicating mobile terminal 110. Preferentially, this <<target>> identifiers list is accessible from Internet for consultation and preferentially edition is possible.

The first alternative of the first embodiment of the method of the present invention is illustrated in FIGS. 1 and 4. When the communicating mobile terminal 110 arrives in a new cell of a cellular telephony network, the one equipped with a base station 130, in order to associate the communicating mobile terminal 110 with this base station 130 in the network, there are exchanges between the base station 130 with the BTS, the BSC, the MSC (acronym for Mobile Switching Center), the HLR, then IMEI (acronym for International Mobile Equipment Identity) authentication, and authorization of connection.

After the connection, the identifier of the communicating mobile terminal 110, as well as the information of CellID (acronym for Cell Identification) of the base station 130 are transmitted by the base station 130 to a database 150 via a server 140. Preferentially, the database 150 is also accessible from Internet. From the identifier of the communicating mobile terminal 110, server 140 finds the list, automatically updated or not, of the <<target>> identifiers of terminal 110, checks if these <<target>> identifiers are geographically close to the communicating mobile terminal 110. If, for example, the identifier of the communicating mobile terminal 120 is in the <<target>> identifiers list of the communicating mobile terminal 110 and like the respective identifiers of the communicating mobile terminals 110 and 120 are in the list of the identifiers of the terminals connected to the base station 130, server 140 sends, to the communicating mobile terminal 110, a message indicating that the communicating mobile terminal 120 is close to the communicating mobile terminal 110. Preferentially, server 140 sends simultaneously, to the communicating mobile terminal 120, a message indicating that the communicating mobile terminal 110 is close to him. The messages are, preferentially, send in SMS form (acronym for Shorts Message System), VMS (acronym for Voice Message System), MMS (acronym for Multi-media Message System) or e-mail (acronym for electronic mail), for example. At reception of these messages, each communicating mobile terminal 110 and 120 activates an alert operation defined by the user (posting, specific ringing or vibrator starting, for example). The user can choose to filter the incoming messages before to start an alert operation (alert if professional contact not called since more than one month, for example).

As it can be understood, in the first alternative of the first embodiment, the method of the present invention includes:
a step 430 of identification of the first communicating mobile terminal 110 or 120 in a distant memory, here database 150, said identification of the first communicating mobile terminal in the distant memory depending on the localization of the said first communicating mobile terminal comprises the cell identifier,
a step 450, carried out by server 140, of identification correspondence search of the first communicating mobile terminal with an identification list of terminals associated with a second communicating mobile terminal 120 or 110, respectively, said step of correspondence search depending on the proximity of said first and second communicating mobile terminals in what the correspondence search is limited to a network cell or this cell and some cells neighboring and
in the case of correspondence, a supply step to the user of the second terminal, 110 or 120, of information representative of the first terminal identification.

More specifically, the identification step of the first communicating mobile terminal 110 or 120 in a distant memory made up of database 150 is carried out by a transmission by a communication network, of the identification of an emitter-receiver, here the base station 130 or a WiFi access-point, to which the first communicating mobile terminal 110 or 120 has connected.

The search step is carried out by server 140 distant from the first communicating mobile terminal, 110 or 120, server having access to said list.

In the case of correspondence, server 140 carries out a supply step to the user of first terminal 110 of information representative of the identification of second terminal 120 or 110, respectively.

FIG. 5 illustrates, in a state-diagram form, a second alternative of the first embodiment of the method of the present invention. Steps 510 and 520 are carried out by the communicating mobile terminal 110 in active mode. Steps 530 to 560 are respectively identical to steps 430 to 460. In this second alternative, it is the communicating mobile terminal 110 which detect, step 510, the changes of base station and then sends to server 140 the information that communicating mobile terminal 110 is now connected to the base station 130 during a step 520.

In this second alternative, a communicating mobile terminal 110 gets information of localization by base stations, known under the name of CellID (by a software like CellTrack, registered trademark) of the base station 130 to which the communicating mobile terminal 110 is connected. It is observed that there are many methods of localizations LBS (acronym for Localization Based Systems) for mobile terminals, the easiest to implement being CellID. This localization is approximate but it is possible to improve it by also recovering the level of the hertzian radio signals of the base stations close to the communicating mobile terminal 110. The communicating mobile terminal 110 sends a message containing its identifier and the information of CellID of the base station 130 and preferentially also other information items of connection for the assistance to positioning like the level of the hertzian radio signals of all the base stations accessible for example to server 140. Server 140 checks if the identifier of the communicating mobile terminal 110 is well present in database 150 and that it has well access to the service of proximity detection and continues the steps described for the first alternative of the first embodiment and FIG. 1.

In alternative of the first and second alternatives of the first embodiment, L130 information and preferentially L110, are sent from server 140 to the communicating mobile terminal and all or part of the steps of treatment 450 or 550 is carried out by the communicating mobile terminal.

After subscription to the service of proximity detection, the user identifier of the communicating mobile terminal 110 is registered in database 150 like having well access to the service.

The communicating mobile terminal 110 sends messages to server 140 preferentially by SMS or GSM packets data and then memorizing to which cells are connected the users of this service of proximity detection.

When the communicating mobile terminal 110 changes of cell, it sends its identifier and its new CellID to server 140.

Two alternatives of operation can be used. In a first alternative, the identifications list associated with each terminal present in a cell is compared with the identifications of the other terminals present in the same cell. In a second alternative, a list of the terminals present in a cell is transmitted by the server to terminal 110 which carries out the comparison between this list with its own list of target terminals identifications and displays the present identifications in these two lists, i.e. the identifications of the target communicating mobile terminals connected to the same base station 130.

Preferentially, the comparison is extended to the base stations close to the base station 130.

To geo-localize the cells and to know the topology of the network, the server can carry out a historical data processing of terminals passages between the cells. Thus, if two terminals having communication means short carried (Bluetooth or WiFi for example), are connected together, i.e., they can exchange information such as, for example, their identifiers, and they are connected to two different base stations, we deduct that these two base stations are close. These base stations being able to be on two completely independent networks, for example WiFi access-points and GSM networks. In the case of heterogeneous networks, it is very interesting to have this kind of correspondence between networks.

It is thus convenient to transmit from communicating mobile terminal 110 to the database 150 also the historical traces of information of the various connections to the different networks to reconstitute, by mixing data (GPS, GSM/CellID, WiFi/MAC, Bluetooth, etc), the terminal route and to deduce the topology of the networks superposition. A meta-network topology is obtained.

The advantage of the first embodiment is that it is inter-operators. Preferentially, each communicating mobile terminal memorizes its extinction times in order to not to induce a topology error. If server 140 knows the network topology of the base stations 130, on request of the communicating mobile terminal 110, it extends the search fields of the communicating mobile terminals to a number of close base stations configurable by the user.

In alternative, the operator also knows the geographical position of his base stations. If the operator decides it, it can add these geographical data in database 150. Server 140 extends the field of detection to the close base stations. Preferentially, server 140 transmits also a background map corresponding to the research zone.

In this embodiment, the data traffic is huge and especially it required there to have access to CellID information on all the mobiles. If the network is not GSM but WiFi for example, the principle remains the same but it is the MAC address (acronym for Media Access Control) of the WiFi access-point which is used instead of CellID.

In the second alternative of the first embodiment, the method of the present invention includes:
an identification step of a first communicating mobile terminal, 110 or 120, in a distant memory, here database 150, said identification of the first communicating mobile terminal in the distant memory depending on the localization of the said first communicating mobile terminal comprises the cell identifier,
a step, carried out by server 140, of correspondence search of the first communicating mobile terminal identification with a list of identifications of terminals associated with a second communicating mobile terminal, 120 or 110, respectively, said step of correspondence search depending on the proximity of said first and second communicating mobile terminals, the search being limited to the terminals being in the same cell or in close cells, and
in case of correspondence, a supply step to the second terminal user of information representative of the first terminal identification.

More specifically, the identification step of the first communicating mobile terminal in the distant memory, here database 150, is carried out by the first communicating mobile terminal which jointly transmits said identification and information representative of its localization.

During the identification step of the first communicating mobile terminal 110 in the distant memory, here database 150, the first communicating mobile terminal determines its localization by the identification of at least one hertzian radio signal short range emitter-receiver, here the base station 130 or a WiFi access-point.

The search step is carried out by server 140 remote from the first communicating mobile terminal, server having access to said list.

In case of correspondence, server 140 carries out a supply step to the user of the first terminal of information representative of the second terminal identification.

In the second embodiment of the method of the present invention illustrated in FIG. 2, we use more terminals resources by coupling point-to-point exchange by short range radio link and Mesh networks, to communicate information, in a bidirectional way. The systems of Mesh networks, implementing a protocol like OLSR (acronym for Optimized Link State Routing), for example, allow two terminals to communicate via third-party intermediate terminals, each one in point-to-point mode. The advantage of such a technique is that we can communicate with terminals potentially at much longer distance than the radio range. The range depends on the initial range of the connection as well as the density of terminals being used as relay. The maximum range is theoretically infinite. It is pointed out that the range of a Bluetooth connection is typically of ten meters compared with hundred meters for a WiFi connection.

In FIG. 2, we observe the mechanism put in place. For example, if the communicating mobile terminal 210 wants to communicate, in a bidirectional way, with the communicating mobile terminal 220, when it is not in direct range, its identification is transmitted to the third-party terminals 230 being in direct range with terminal 210, then retransmitted by those one to the terminals which are in their range, until the number of retransmissions reaches a predetermined value.

At reception of these identifications, each terminal compares them with its list of target terminals identifications and informs its user in case of correspondence, by providing each identification data so found.

In its second embodiment, the method of the present invention includes:
an identification step of a first communicating mobile terminal 210 in a distant memory, here made up of the memory of the terminal 220 or the one of the terminal 230, said identification of the first communicating mobile terminal in the distant memory depending on the localization of the said first communicating mobile terminal, the transmission range of the identification of terminal 210 being reduced by the number of authorized successive retransmissions,
a correspondence search step carried out by the second communicating mobile terminal 220 of the first communicating mobile terminal identification with an identifications list of terminals associated with a second communicating mobile terminal, said correspondence search step depending of the proximity of said first and second communicating mobile terminals, only the identifications of the close terminals like the terminal 210 being used and
in case of correspondence, a supply step to the user of the second terminal of information representative of the first terminal identification.

More particularly, the identification step of the first communicating mobile terminal 210 in a distant memory, here the memory of one of the terminals 220 and 230, is carried out by a direct point-to-point radio link between said first communicating mobile terminal and a third-party communicating terminal different from the said second communicating mobile terminal.

The correspondence search step is carried out by said second communicating mobile terminal 220 at reception, coming from a third-party communicating terminal 230 different from the first communicating mobile terminal, of communicating mobile terminals identifications.

FIG. 3 illustrates a third embodiment using terminals resources. It consists in using the short range radio link point-to-point techniques and to use two properties of these terminals:
to be mobile and
to be able to memorize information.

In this embodiment, some relay terminals are used as buffer memory for the data to be transmitted and the data transmissions are mono-directional, not synchronized and not guaranteed.

The quantity of memory allocated to the implementation of the method and/or the service being limited in each terminal, preferentially, we control the quantity of information stored in the terminal. On the temporal side, by taking the date of the received data by known time-stamping techniques, and by defining a configurable maximum retention time, we eliminate the oldest data. On the space side, to consider the possible moving of the communicating terminals, preferentially, we count the changes of base stations identifiers and we eliminate the identifications collected in the oldest reached cells. Preferentially, the chronology of base station changes is memorized to check that there is no oscillation between several stations base, for example. It gives an idea of the mobile moving speed and, by also integrating the retention time, we obtain an approximate distance allowing to eliminate the identifications corresponding to the most distant terminals.

In FIG. 3, we observe the mechanism installed. The tables of FIG. 3 indicate at times t0, t1 and t2, the content of the memories (M) of the terminals A, B and C respectively 310,320 and 330. These memories contain information (I), time-stamped (t) transmitted by each mobile in the form of information tables (T). For example, mobile 310 transmits information (of identification, but also of CellID, for example) to any mobile passing close by. At the time t0, we suppose all the mobiles are reset. At t1, mobile 310 transmits information (I_{A}) to mobile 330. Inversely, terminal 330 transmits information (I_{C}) to mobile 310. It is important to note that there is relativity of time t1 viewed by each mobile. Suppose that mobile 330 moves towards mobile 320. At time t2, mobile 330 transmits information (I_{C}) to mobile 320. But especially, mobile 330 also transmits to mobile 320 the information of mobile 310 with their temporal reference (I_{A} and t_{2C}−t_{1C}).

The mobile 320 then memorizes these information items with their temporal and hop references: (I_{C} to t_{2B}, hop=0) and especially (I_{A} to t_{1B}, hop=1). Mobile 320 can indeed compensate the relative temporal drifts by calculating t_{1B}=t_{2B}−(t_{2C}−t_{1C}). Inversely, mobile 320 transmits information (I_{B}) to mobile 330. Then, mobile 320, out of reach of mobile 310 did it received the information of mobile 310 via mobile 330 by a viral type transmission where mobile 330 plays the role of healthy bearer. If the transmitted information is an identifier, mobile 320 was then informed of the presence of mobile 310 in its vicinity with connection checking to the same cell if CellID information were also transmitted. This can then start the scan of the local address book to check if mobile 310 (and also mobile 330, of course) is known from mobile 320 and, if so, to start the activation of the vibrator or a ring tone specific to a group, for example. To limit the size of the stack used to memorize these information items, it is necessary to limit the effects of remembering. To limit the effects of temporal remembering, we can purge the buffer memories after a certain threshold time (i.e., if time-stampings are lower than t_{threshold} then the corresponding data are erased). Similarly, to limit the effects of space remembering, we can limit the number of authorized hops with a Hops_{threshold} parameter or consider (and so transmit also) a number of passed CellID.

In its third embodiment, the method of the present invention includes:
an identification step of a first communicating mobile terminal 310 in a distant memory here made up of the memory of terminal 320 or the one of terminal 330, said identification of the first communicating mobile terminal in the distant memory depending on the localization of the said first communicating mobile terminal, the transmission range of the identification of terminal 310 being reduced by the number of authorized successive retransmissions,
a correspondence search step carried out by the second communicating mobile terminal 320, of the first communicating mobile terminal identification with a list of identifications of terminals associated with a second communicating mobile terminal, said step of correspondence search depending on the proximity of the said first and second communicating mobile terminals, only the identifications of the close terminals like terminal 310 being used and
in case of correspondence, a supply step to the user of the second terminal of information representative of the first terminal identification.

More particularly, the identification step of the first communicating mobile terminal 210 in a distant memory, here the memory of terminals 320 and 330, is carried out by a direct point-to-point radio link between said first communicating mobile terminal and a third-party communicating terminal different from the said second communicating mobile terminal.

The correspondence search step is carried out by said second communicating mobile terminal 320 at reception, coming from a third-party communicating terminal 330 different from the first communicating mobile terminal, of identifications of communicating mobile terminals.

The fourth embodiment, illustrated in FIG. 6, consists in recovering localization information by terminal 610, by positioning with known techniques in <<GPS>> (acronym for Global Positioning System) systems or Galileo using terrestrial satellites 660, or any other radio technique of localization. Then terminal 610 sends, via a base station 630, this information to a server 640 memorizing in a database 650 the positioning information of terminals 610 and 620. The communicating mobile terminal 620 carries out the same steps than the terminal 610.

If the transmission of information is not immediate, temporal information is also transmitted to the database. A software on terminal 610 can then question server 640 and display the corresponding target mobiles, with or without background map, and display their distances to the communicating mobile terminal. If a configurable distance threshold is not reached by these distances, a proximity alert is started on the communicating mobile terminal 610. In this embodiment, the data traffic emitted by each terminal is high and it is necessary to have all the mobile terminals equipped with localization system.

In its fourth embodiment, the method of the present invention includes:
an identification step of a first communicating mobile terminal 610 in a distant memory, here made up of database 650, said identification of the first communicating mobile terminal in the distant memory depending on the localization of the said first communicating mobile terminal, this localization being associated with the first terminal identification,
a correspondence search step, carried out by server 640, of the identification of the first communicating mobile terminal with an identifications list of terminals associated with a second communicating mobile terminal 620, said step of correspondence search depending on the proximity of said first and second communicating mobile terminals, being geographically limited and
in case of correspondence, a supply step to the second terminal user of information representative of the first terminal identification.

More particularly, the identification step of the first communicating mobile terminal 610 in the distant memory, here database 650, is carried out by the first communicating mobile terminal which jointly transmits said identification and information representative of its localization.

During the identification step of the first communicating mobile terminal 610 in the distant memory, here database 650, the first communicating mobile terminal determines its localization according to positioning hertzian radio signals.

The search step is carried out by server 640 distant from the first communicating mobile terminal 610, server having access to said list.

In case of correspondence, server 640 carries out a supply step to the user of first terminal 610 of information representative of the second terminal 620 identification.

The coverage of this invention is not limited to the embodiments described and represented but spreads, on the contrary, over any combination of the embodiments previously described. In particular, according to the peripherals characteristics, the computing power and their available quantity of memory, their available energy and/or the subscription type that they use with their mobile phone operator, a method in conformity with the present invention makes it possible to make some terminals work in some embodiments and other terminals according to other embodiments.

The implementation of some embodiments of the invention is achieved by using software (in assembly language, Java (registered trademark), C, . . . ) executed on one or more processors (application processor, SIM card, baseband processor, . . . ) of the communicating terminal.

1-10. (canceled)

11. Method for the transmission of data between communicating mobile terminals, that comprises:
an identification step of a first communicating mobile terminal in a distant memory, said identification of the first communicating mobile terminal in the distant memory depending on the localization of the said first communicating mobile terminal,
a correspondence search step of the first communicating mobile identification with a list of identifications of terminals associated with a second communicating mobile terminal, said step of correspondence search depending on the proximity of said first and second communicating mobile terminals and
in case of correspondence, a supply step to the second terminal user of information representative of the first terminal identification.

12. A method according to claim 11, wherein the identification step of the first communicating mobile terminal in a distant memory is carried out by a direct point-to-point radio link between said first communicating mobile terminal and a third-party communicating terminal different from the said second communicating mobile terminal.

13. A method according to claim 12, wherein the correspondence search step is carried out by said second communicating mobile terminal at reception, coming from a third-party communicating terminal different from the first communicating mobile terminal, of identifications of communicating mobile terminals.

14. A method according to claim 11, wherein the identification step of the first communicating mobile terminal in a distant memory is carried out by the first communicating mobile terminal which jointly transmits said identification and information representative of its localization.

15. A method according to claim 14, wherein, during the identification step of the first communicating mobile terminal in a distant memory, the first communicating mobile terminal determines its localization according to positioning hertzian radio signals.

16. A method according to claim 14, wherein, during the identification step of the first communicating mobile terminal in a distant memory, the first communicating mobile terminal determines its localization by the identification of at least one emitter-receiver of short range hertzian radio signals.

17. A method according to claim 11, wherein the identification step of the first communicating mobile terminal in a distant memory is carried out by a transmission by a communication network, of the identification of an emitter-receiver to which the first communicating mobile terminal has connected.

18. A method according to claim 14, wherein the search step is carried out by a server distant from the first communicating mobile terminal, server having access to said list.

19. A method according to claim 11, that comprises, in case of correspondence, a supply step to the first terminal user of information representative of the second terminal identification.

20. Device for the transmission of data between communicating mobile terminals, that comprises:
an identification mean of a first communicating mobile terminal in a distant memory, said identification of the first communicating mobile terminal in the distant memory depending on the localization of the said first communicating mobile terminal,
a correspondence search mean of the identification of the first communicating mobile terminal with an identifications list of terminals associated with a second communicating mobile terminal, adapted so that said correspondence search depends on the proximity of said first and second communicating mobile terminals and
a supply mean adapted, in case of correspondence, to provide to the second terminal user information representative of the first terminal identification.
